(19) United States
(12) Patent Application Publication
(10) Pub. No.: US 2017/0187272 A1
(43) Pub. Date: Jun. 29, 2017

(54) Single Phase Permanent Magnet Motor

(71) Applicant: Johnson Electric S.A., Murten (CH)

(72) Inventors: Yue LI, Hong Kong (CN); Chui You ZHOU, Shenzhen (CN); Yong WANG, Shenzhen (CN); Yong LI, Shenzhen (CN)

(21) Appl. No.: 15/391,076

(22) Filed: Dec. 27, 2016

(30) Foreign Application Priority Data
Dec. 25, 2015 (CN) 2015 1099 5374.6

(51) Int. Cl. H02K 21/14; H02K 1/14; H02K 3/18; H02K 1/27

(52) U.S. Cl. CPC H02K 21/14; H02K 1/2706; H02K 1/148; H02K 1/145; H02K 3/18

(57) ABSTRACT

A single phase permanent magnet motor includes a stator and a rotor. The stator includes a stator core with windings. The stator core includes a yoke and claw-poles. Each claw-pole forms an arc pole face which is an involute curved face. All arc pole faces cooperatively define a space for receiving the rotor. A gradually changing uneven air gap is defined between the arc pole faces and the rotor. When the motor powers off and stops, the pole axis of the rotor is offset from the central axis of the claw-poles by a certain angle to avoid the rotor to stop at a dead point position, thus facilitating next startup of the motor.

### CROSS REFERENCE TO RELATED APPLICATIONS

This non-provisional patent application claims priority under 35 U.S.C. §119(a) from Patent Application No. 201510995374.6 filed in The People's Republic of China on Dec. 25, 2015.

### FIELD OF THE INVENTION

This invention relates to single phase permanent magnet motors, and in particular, to a single phase permanent magnet inner-rotor motor.

### BACKGROUND OF THE INVENTION

A single phase permanent magnet motor generally includes a stator core, stator windings, and a permanent magnet rotor. The stator core forms claw-poles, and the stator windings are wound around the claw-poles. When the windings are energized, the claw-poles are polarized. Each of the claw-poles acts as one magnetic pole of the stator core, and cooperates with permanent magnetic poles of the permanent magnet rotor to push the rotor to rotate continuously, which further drives the load to rotate or translate, such as, drives a window to open or close in the application of automobiles.

In general, the number of the magnetic poles of the stator core of the single phase permanent magnet motor is the same as the number of the magnetic poles of the permanent magnet rotor. As a result, when the motor is de-energized and stopped, the permanent magnetic poles of the permanent magnet rotor are aligned with the magnetic poles of the stator core along the radial direction of the motor, thus forming a dead point, which makes the rotor unable to start up when the motor is energized again.

### SUMMARY OF THE INVENTION

In view of above, there is a desire for a single phase permanent magnet motor which can effectively avoid forming the dead point when the motor powers off, so that the motor can start up successfully when the motor is energized again.

A single phase permanent magnet motor includes a stator and a rotor. The stator includes a stator core and windings wound around the stator core. The stator core includes a yoke and at least two claw-poles extending from the yoke. Each of the claw-poles forms an arc pole face. The arc pole faces of the claw-poles cooperatively define a space. The rotor is rotatably disposed in the space of the stator. The rotor includes at least two permanent magnetic poles. The arc pole face of each claw-pole is an involute curved face, such that an uneven air gap is defined between the arc pole faces and the rotor.

Preferably, each of the permanent magnetic poles comprises a magnetic pole face facing the arc pole face of the stator, and the uneven air gap is defined between the arc pole faces and the magnetic pole faces.

Preferably, a radial distance between each arc pole face and a central axis of the rotor changing gradually from one end of the arc pole face to the other end of the arc pole face along a circumferential direction of the arc pole face, the uneven air gap between each arc pole face and the rotor gradually changes from one end to the other end.

Preferably, the claw-poles are spaced from each other, distal ends of each two neighboring claw-poles define a gap therebetween, and the arc pole faces are not continuous in the circumferential direction and are interrupted at the gaps between the claw-poles.

Preferably, the gap between the neighboring claw-poles is 0-6 times of a maximum value of the air gap.

Preferably, the gap between the neighboring claw-poles is greater than two times of the maximum value of the air gap and less than four times of the maximum value of the air gap.

Preferably, a width of the gap between the claw-poles is substantially two times of the maximum width of the air gap between the stator and the rotor.

Preferably, the stator core is a U-shaped core, and two arms extend from two ends of the yoke, the two arms are parallel to and spaced from each other, each of the arms forms one of the claw-poles at a distal end thereof, and an inner surface of each claw-pole facing the other claw-pole concaves to form the arc pole face.

Preferably, each of the claw-poles is C-shaped, and two ends of each of the claw-poles protrude towards the other claw-poles to form pole-tips.

Preferably, the stator core is a substantially θ-shaped core, and comprises two yokes parallel to and spaced from each other, two arms respectively interconnect opposite ends of the two yokes, the number of the claw-poles is two, the two claw-poles extend perpendicularly towards each other from middles of the two yokes, and an inner surface of each claw-pole facing the other claw-pole concaves to form the arc pole face.

Preferably, the yoke is annular, a plurality of arms extends radially and inwardly from an inner surface of the yoke, the claw-poles are respectively formed at radial inner ends of the arms, each claw-pole is arc-shaped, and a radial inner surface of each claw-pole functions as the arc pole face of the claw-pole.

Preferably, the core is formed by splicing a plurality of segments, each of the segments comprises an arc-shaped yoke portion, and an arm extending from a radial inner surface of the yoke portion, the claw-poles are respectively formed at distal ends of the aims, one end of each yoke portion in the circumferential direction protrudes outwardly to form a tab, and the other end of each yoke portion concaves to define a recess, and the tab of each yoke portion engages in the recess of one neighboring yoke portion to form the annular yoke.

Preferably, the yoke is substantially rectangular, two arms extend from inner surfaces of two opposite sides of the yoke, the number of the claw-poles is two, the two claw-poles are respectively formed at distal ends of the arms, two auxiliary claw-poles are connected at inner surfaces of the other two opposite sides of the yoke, the two claw-poles and the two auxiliary claw-poles are alternately arranged along the circumferential direction, a radial size of each auxiliary claw-pole is less than that of each claw-pole, and an inner surface of each of the claw-poles and the auxiliary claw-poles concaves to form the arc pole face.

Preferably, the yoke is oblong, the two arms extend integrally from a pair of shorter sides of the yoke, and the two auxiliary claw-poles are formed separately and then connected to a pair of longer sides of the yoke, respectively.

Preferably, the arc pole face of each auxiliary claw-pole is an involute curved face, and the air gap between the arc pole face of each auxiliary claw-pole and the rotor is uneven.

Preferably, the arc pole face of each of the claw-poles and auxiliary claw-poles extends spirally outward along a same circumferential direction.

Preferably, the windings are only wound around the arms which are connected to the claw-poles.

In comparison with the prior art, the core of the single phase permanent magnet motor of the present disclosure forms involute arc pole faces, and the stator and the rotor forms the uneven air gap, which causes the pole axis of the rotor to be offset from the central axis of the claw-poles by a certain angle when the motor powers off and stops, such that the rotor of the motor is prevented from stopping at the dead point position, thus facilitating next startup of the motor.

### BRIEF DESCRIPTION OF THE DRAWINGS

FIG. 1 is a schematic view of a single phase permanent magnet motor according to an embodiment of the present disclosure.

FIG. 2 is a front view of the motor of FIG. 1.

FIG. 3 is a schematic view of a stator core of the motor of FIG. 1.

FIG. 4 is a schematic view of a single phase permanent magnet motor according to another embodiment of the present disclosure.

FIG. 5 is a front view of the motor of FIG. 4.

FIG. 6 is a schematic view of the stator core of the motor of FIG. 4.

FIG. 7 is a schematic view of a single phase permanent magnet motor according to another embodiment of the present disclosure.

FIG. 8 is a front view of the motor of FIG. 7.

FIG. 9 is an enlarged view of a half of the motor of FIG. 7.

FIG. 10 is a schematic view of a stator of the motor of FIG. 7.

FIG. 11 is a front view of the stator of FIG. 10.

FIG. 12 is a partly exploded view of the stator of FIG. 11.

FIG. 13 is a schematic view of the core of the stator of FIG. 11.

FIG. 14 is a schematic view of a rotor of the motor of FIG. 7.

FIG. 15 is a schematic view of a motor according to still another alternative embodiment of the present disclosure.

FIG. 16 is a front view of the motor of FIG. 15.

FIG. 17 is a schematic view of the stator of the motor of FIG. 15.

FIG. 18 is a front view of the stator of FIG. 17.

FIG. 19 is a schematic view of the core of the stator of FIG. 18.

FIG. 20 is a schematic view of the rotor of the motor of FIG. 15

FIG. 21 is a front view of the rotor of FIG. 20.

### DETAILED DESCRIPTION OF THE EMBODIMENTS

The single phase permanent magnet motor of the present disclosure may be used to directly or indirectly (through transmission mechanisms, such as a gear, a worm gear, a worm and the like) drive external equipment, such as windows of automobiles, wheels of toys, impellers, to translate or rotate. Technical solutions and advantages of the present invention will become apparent by consideration of the following description of embodiments of the single phase permanent magnet motor of the present invention with reference to the accompanying drawings. The drawings are for reference and illustration only, and should not be regarded as limiting. Dimensions of components and features shown in the drawings are generally chosen for convenience and clarity of presentation and are not necessarily shown to scale.

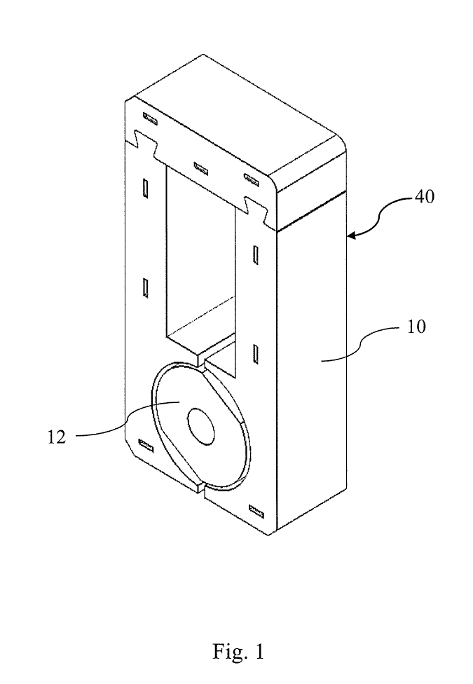

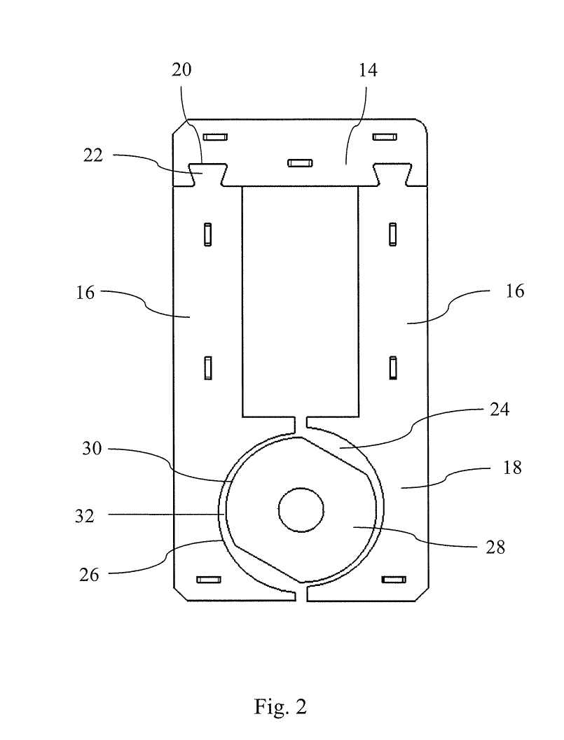

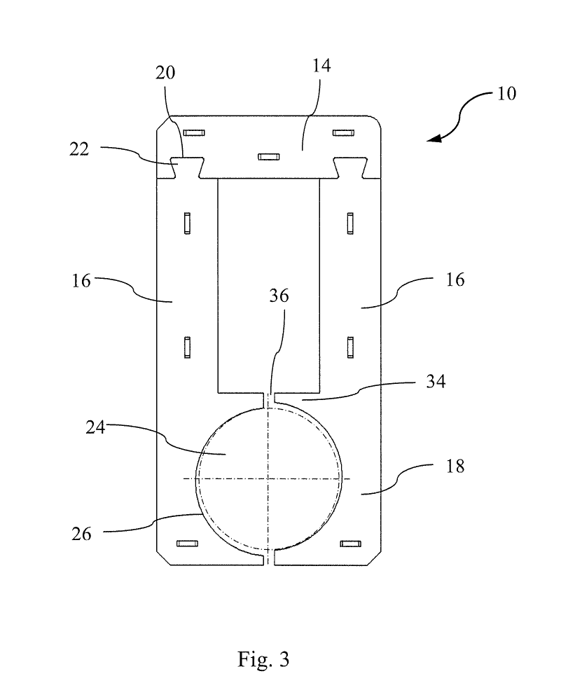

FIG. 1 shows an embodiment of the single phase permanent magnet motor of the present disclosure. Preferably, the motor is an inner-rotor motor, and includes a stator 40 with a stator core 10 made of a conductive soft magnetic material, and a permanent magnet rotor 12 rotatably disposed in the stator core 10. Please refer to FIG. 2 and FIG. 3, in this embodiment, the stator core 10 is a U-shaped core, and includes a block-shaped yoke 14 and two aims 16 extending perpendicularly and outwardly from two ends of the yoke 14, respectively. The arms 16 allow windings to be wound thereon. A distal end of each arm 16 forms a claw-pole 18. When the motor starts, the windings wound around the arms 16 are energized to generate induced electromagnetic field, which causes the claw-poles 18 to be polarized. The polarized claw-poles 18 function as magnetic poles of the core 10. The two claw-poles 18 have opposite polarities at any time. In the drawings, some elements of the stator, such as windings, an electric circuit for controlling electric currents of the windings, and a motor housing, are not shown, which can be corresponding parts of the single phase permanent magnet motor in the art.

Preferably, the yoke 14 and the two arms 16 of the core 10 are respectively formed by stacking a plurality of laminations, and the laminations are then assembled together by mechanical connections to form the core 10. Thus, the windings can be firstly wound around each of the arms 16, and then the arms 16 with windings wound thereon are connected to the yoke 14, such that the windings can be wound more conveniently and quickly, without being subject to the limitations of the construction and size of the core 10. Preferably, the yoke 14 concaves inwardly to form locking slots 20 at two positions near the two ends of the yoke 14. Each of the arms 16 protrudes outwardly to from a locking block 22 at one end thereof facing to the yoke 14. During assembly, the locking block 22 of each arm 16 engages in one corresponding locking slot 20 of the yoke 14 to connect the arms 16 and the yoke 14 together to form the core 10. Preferably, the locking slots 20 and the locking blocks 22 form dovetail-type connections, avoiding disengagement after connection. In other embodiments, the locking slots 20 can also be formed in the arms 16 and, correspondingly, the locking blocks 22 are formed on the yoke 14.

The two arms 16 both are elongated, being parallel to and spaced from each other. The claw-poles 18 are formed at ends of the arms 16 away from the yoke 14. A space 24 is defined between the two claw-poles 18 for receiving the rotor 12 therein. An inner surface of each claw-pole 18 facing the space 24 functions as an arc pole face 26 of the claw-pole 18, which is a concave, smooth curved face. In this embodiment, the claw-poles 18 are substantially C-shaped, and the arc pole face 26 of each of the claw-poles 18 is an involute curved face. Each arc pole face 26 extends progressively spirally outward along the counter-clockwise direction, as viewed from the aspect illustrated in FIG. 3. In other words, the diameter of each arc pole face 26 increases gradually along the counter-clockwise direction. The space 24 surrounded by the arc pole faces 26 of the claw-poles 18 is irregular, and is substantially circular column-shaped. shaped. A distance between each of the arc pole faces 26 and a central axis of the space 24, i.e. a central axis of the rotor 12, increases gradually along a spiral direction of the arc pole faces 26, i.e. the counter-clockwise direction.

In this embodiment, as shown in FIG. 2, the rotor 12 in whole has an obround cross-section, and a rotary shaft (not shown) is inserted through an interior of the rotor 12, for connecting to and hence driving a load to operate. The rotor 12 includes permanent magnetic poles 28, which are the same as the claw-poles 18 of the stator core 10 in number. An external surface of each permanent magnetic pole 28 functions as a magnetic pole face 30 thereof, which is opposed to the arc pole face 26 of the claw-pole 18. Preferably, the magnetic pole faces 30 of the permanent magnetic poles 28 are located on a cylindrical surface which has a central axis coinciding with that of the rotor 12. Preferably, the outer diameter of the cylindrical surface is less than a minimum value of the diameter of the arc pole faces 26 of the claw-poles 18 of the stator core 10. During assembly, the central axis of the rotor 12 is kept coinciding with the central axis of the space 24 between the claw-poles 18. The magnetic pole faces 30 of the permanent magnetic poles 28 of the rotor 12 face to and are spaced from the arc pole faces 26 of the claw-poles 18 of the core 10 along the radial direction, with an air gap 32 defined therebetween, which avoids interference of the rotor 12 during rotation with the core 10, thus ensuring stable rotation of the rotor 12.

Due to the involute arc pole faces 26 of the claw-poles 18 of the core 10, the air gap 32 defined between each arc pole face 26 and the corresponding magnetic pole face 30 of the rotor 12 has a radial width gradually increasing along the spiral direction of the arc pole face 26, i.e. the counter-clockwise direction. Thus, the stator 40 and the rotor 12 define the gradually changing, uneven air gap 32 therebetween, such that, when the motor powers off and stops, the pole axis of the rotor 12 is offset from the central axis of each claw-pole 18 by a certain angle, i.e. avoids the dead point position, thus ensuring the successful startup of the motor when the motor is energized again. It should be understood that, in other embodiments, each arc pole faces 26 of the claw-poles 18 can be designed to be involute curved faces that extend spirally outward along the clockwise direction according to the rotation direction of the motor, which likewise cooperate with the magnetic pole faces 30 of the permanent magnetic poles 28 of the rotor 12 to form an uneven air gap therebetween, thus ensuring that the rotor 12 avoids the dead point when the motor stops.

Preferably, two ends of the claw-pole 18 of each arm 16 along the circumferential direction extend outwardly towards the other arm 16 to form pole-tips 34, which make each claw-pole 18 have a greater arc length that is close to a semi-circle. Thus, opposing pole-tips 34 of the two claw-poles 18 define a narrow gap 36 therebetween, such that the arc pole faces 26 of the two claw-poles 18 do not form a continuous circumferential surface but instead are interrupted by the narrow gap along the circumferential direction to reduce magnetic flux leakage and cogging torque, thereby achieving efficient and stable operation of the motor. More preferably, a width of discontinuity of the arc pole faces 26 in the circumferential direction, i.e. a width of the gap 36 between the claw-poles 18, is substantially two times of the maximum width of the air gap 32 between the stator 40 and the rotor 12.

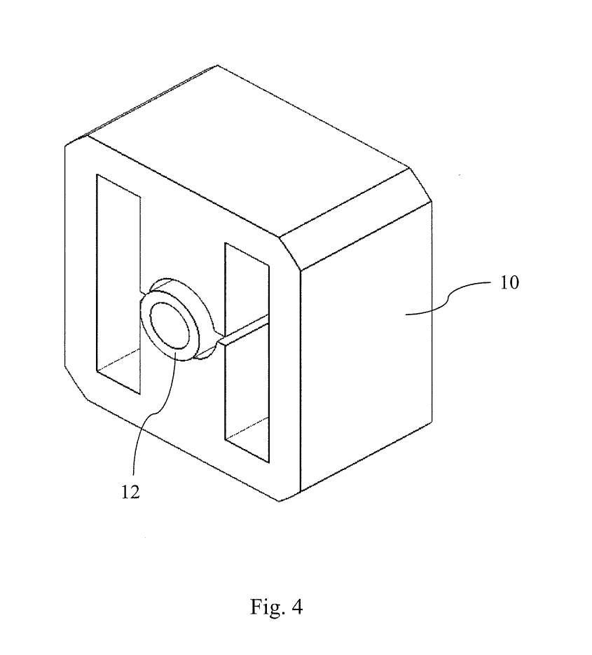

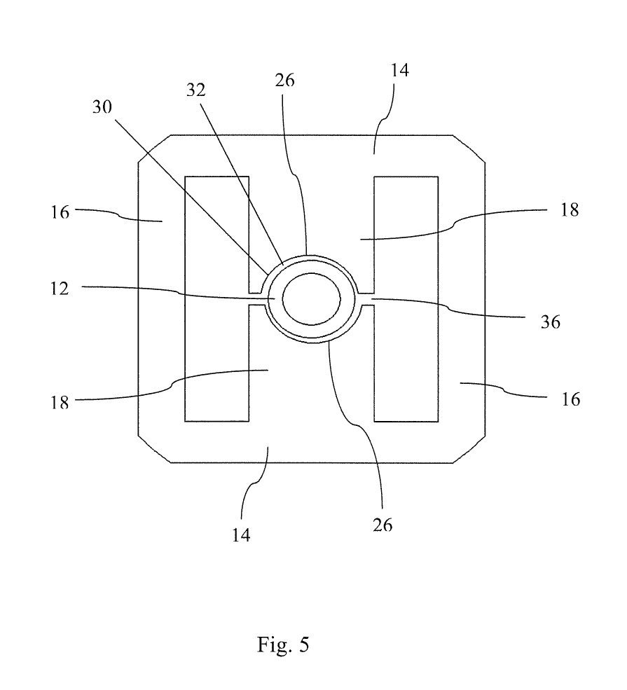

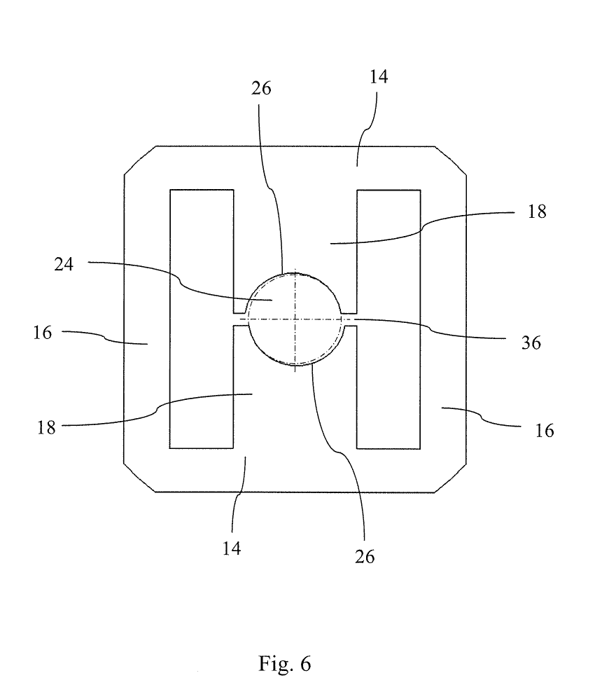

FIGS. 4-6 show another embodiment of the single phase permanent magnet motor of the present disclosure, which differs mainly in that: the stator core 10 of the motor of this embodiment is a θ-shaped core, and includes two elongated yokes 14 parallel to and spaced from each other, two arms 16 respectively interconnecting opposite ends of the two yokes 14, and a claw-pole 18 extending perpendicularly from a middle of each yoke 14. The two claw-poles 18 are opposed to and spaced from each other. An inner surface of each claw-pole 18 faces the other claw-pole 18 concaves to form an arc pole face 26. The arc pole faces 26 of the two claw-poles 18 define a space 24 therebetween for receiving the rotor 12. Similarly, as shown in FIG. 5 and FIG. 6, the arc pole face 26 of each claw-pole 18 is an involute curved face, and cooperates with the magnetic pole faces 30 of the rotor 12 to form an uneven air gap 32, which ensures the pole axis of the rotor 12 to be offset from the central axis of the claw-poles 18 to thereby avoid the dead point position when the motor powers off and stops. In addition, the two claw-poles 18 are spaced from each other, and the arc pole faces 26 are interrupted at the gaps 36 between the claw-poles 18 and are not continuous in the circumferential direction, thereby effectively reducing the magnetic flux leakage.

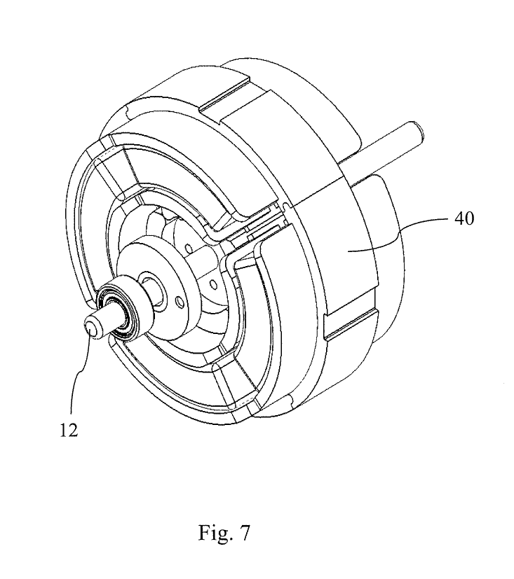

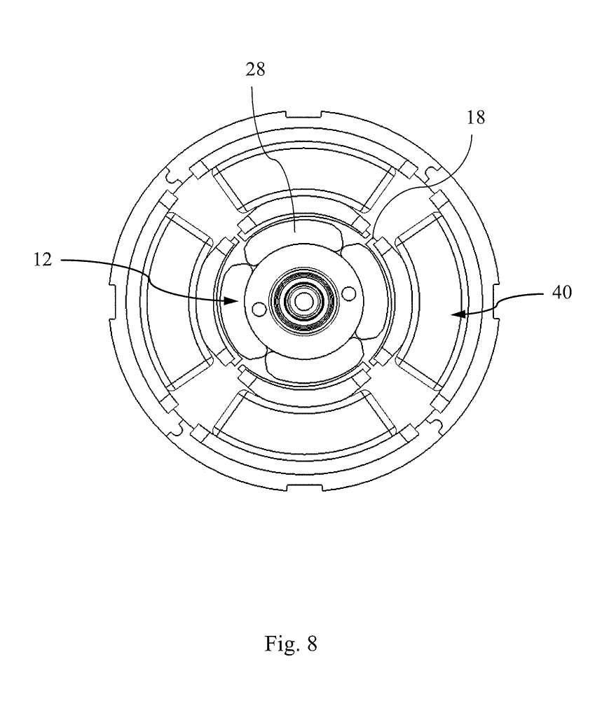

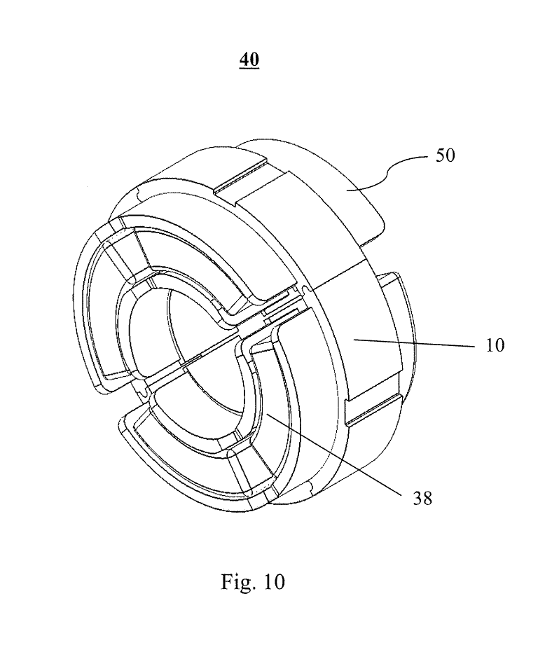

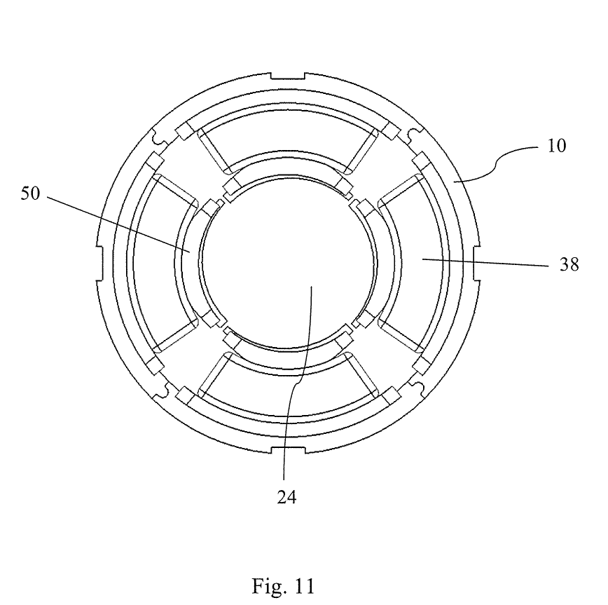

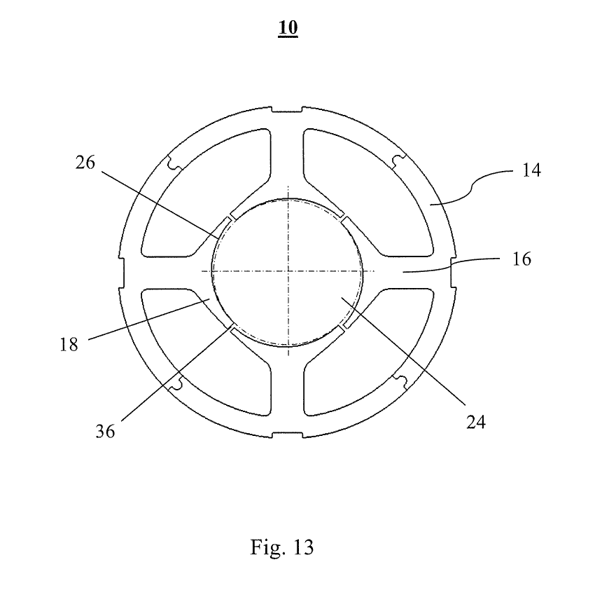

FIGS. 7-14 show a third embodiment of the single phase permanent magnet motor of the present disclosure, which differs mainly in that: the stator core 10 of the motor of this embodiment is a ring-shaped core which, as shown in FIG. 13, includes an annular yoke 14 and a plurality of arms 16 (four arms 16 illustrated in the drawings) extending radially and inwardly from an inner side of the yoke 14. The windings 38 are wound around the arms 16 of the core 10, and cooperatively form the stator 40 of the motor, as shown in FIGS. 10-11. Each of the arms 16 forms an arc-shaped claw-pole 18 at a radial inner end thereof. Distal ends of neighboring claw-poles 18 define a gap 36 therebetween. A radial inner surface of each claw-pole 18 is concaved and acts as an arc pole face 26 of the claw-pole 18. Preferably, as shown in FIG. 13, each arc pole face 26 is an involute curved face and extends spirally outwards along the clockwise direction as viewed from the aspect shown in the figure. The arc pole faces 26 cooperatively define the space 24 which is substantially column-shaped for receiving the rotor 12.

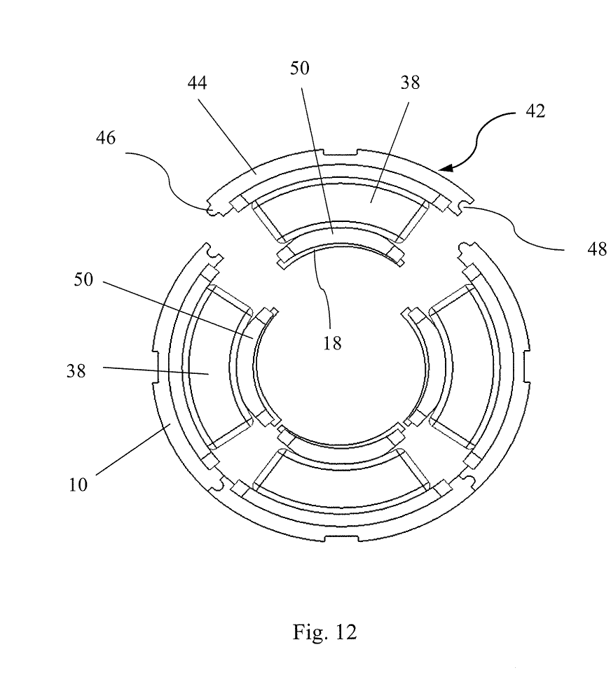

Preferably, as shown in FIG. 12, the core 10 is formed by splicing a plurality of segments 42. Each of the segments 42 includes an arc-shaped yoke portion 44, an arm 16 extending from a middle of a radial inner surface of the yoke portion 44, and a claw-pole 18 formed at a distal end of the arm 16. One end of the yoke portion 44 in the circumferential direction protrudes outwardly to form a tab 46, and the other end concaves to define a recess 48. During assembly, as shown in FIG. 12, the tab 46 of each yoke portion 44 engages in the recess 48 of the neighboring yoke portion 44, such that the yoke portions 44 are connected end to end to form the annular yoke 14, and the core 10 is thereby accomplished. Due to the yoke 14 being formed by the plurality of spliced segments 42, the windings 38 can be wound around the arms 16 of respective segments 42 before splicing of the segments 42. Thus, winding of the windings 38 is not limited by the construction and size of the core 10. In order to avoid short circuit of the windings 38, an insulating bracket 50 can be mounted around each of the segments 42 to separate the segments 42 from the windings 38.

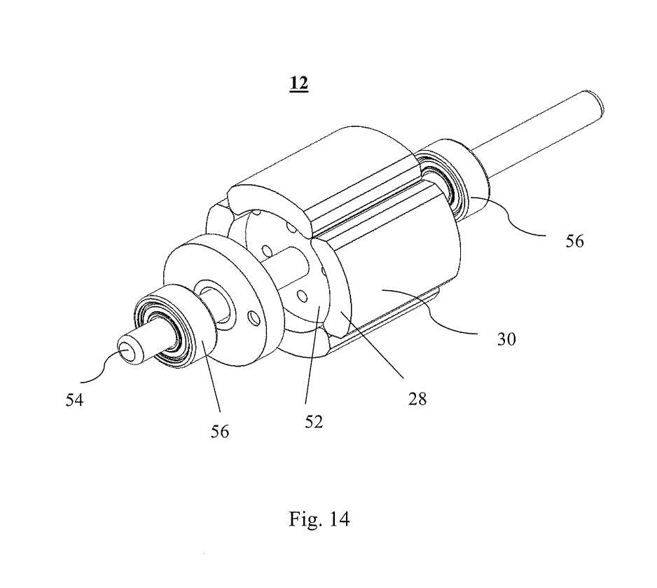

As shown in FIG. 14, in this embodiment, the rotor 12 further includes a rotor core 52. The rotor core 52 is column-shaped, and is fixedly mounted around the shaft 54 and is coaxial with the shaft 54. The permanent magnetic poles 28 are affixed to an outer surface of the rotor core 52, and the number of the permanent magnetic poles 28 is equal to the number of the claw-poles 18 , both being four in this embodiment. Each of the permanent magnetic poles 28 acts as one magnetic pole of the rotor 12. Neighboring permanent magnetic poles 28 have opposite polarities. Outer surfaces of the permanent magnetic poles 28 function as the magnetic pole faces 30 thereof, which directly face the arc pole faces 26 of the claw-poles 18 of the stator 40. Preferably, the magnetic pole faces 30 of the permanent magnetic poles 28 are commonly located on a cylindrical surface which has an axis coinciding with that of the shaft 54. Two ends of the shaft 54 extend outwardly to connect to a load. Preferably, bearings 56 are mounted around the shaft 54 to support the shaft 54 for rotation.

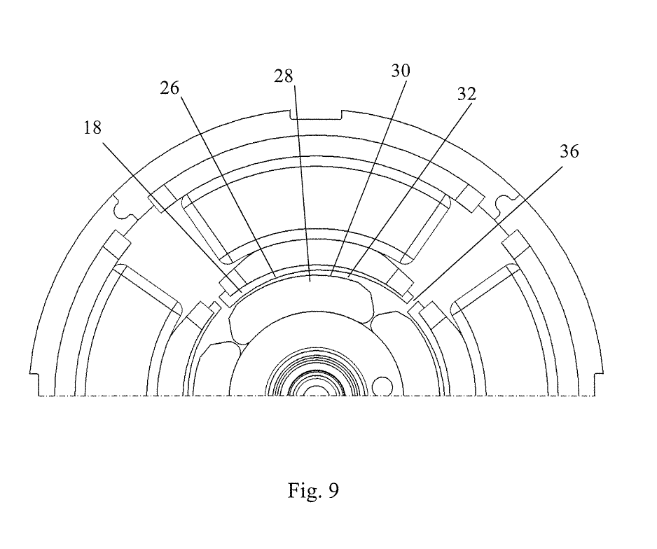

In assembly of the rotor 12 and the stator 40 to form the motor, as shown in FIGS. 7-9, because the arc pole faces 26 of the claw-poles 18 of the stator 40 are involute curved faces, the arc pole faces 26 cooperate with the magnetic pole faces 30 of the permanent magnetic poles 28 of the rotor 12 to define the uneven air gap 32 therebetween. The air gap 32 has a radial width gradually increasing along the spiral direction of the arc pole face 26 (along the clockwise direction as viewed from FIG. 9), which ensures that the pole axis of the rotor 12 is offset from the central axis of the claw-poles 18 to avoid the dead point position when the motor powers off and stops. In addition, the gaps 36 are defined between the claw-poles 18 of the stator 40 and, as a result, the arc pole faces 26 of the claw-poles 18 are interrupted at the gaps 36 between the claw-poles 18. Therefore, the arc pole faces 26 of the claw-poles 18 are not continuous in the circumferential direction, which effectively reduces the magnetic flux leakage and ensures efficiency of the motor.

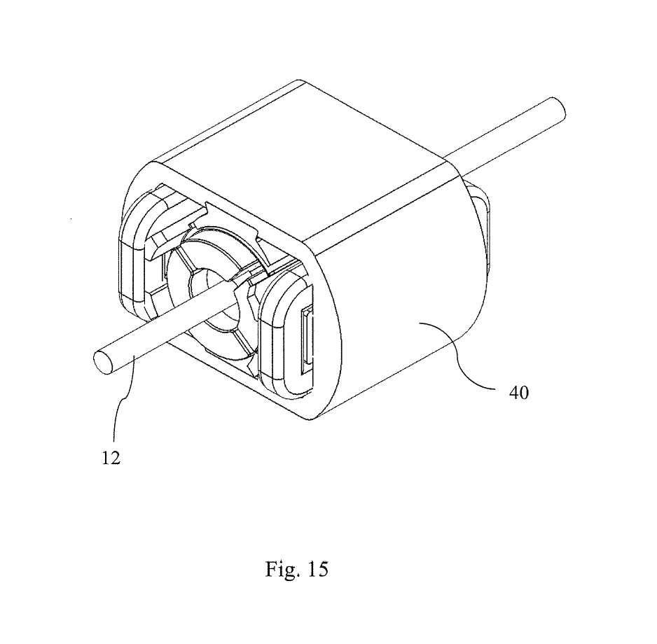

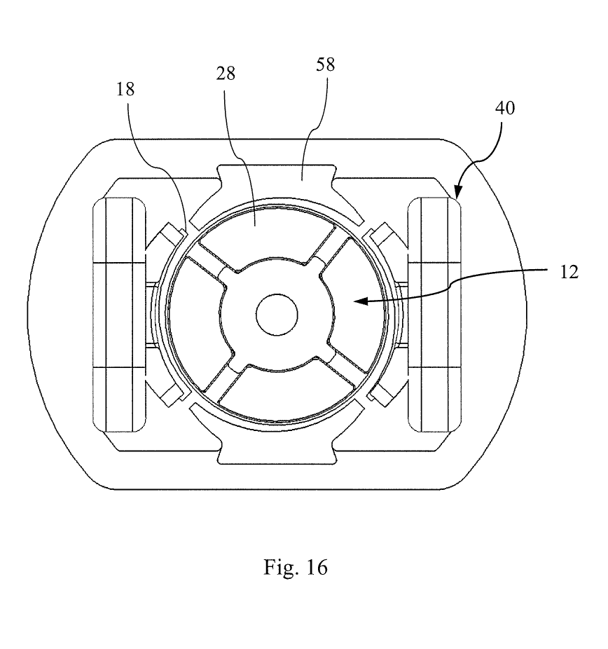

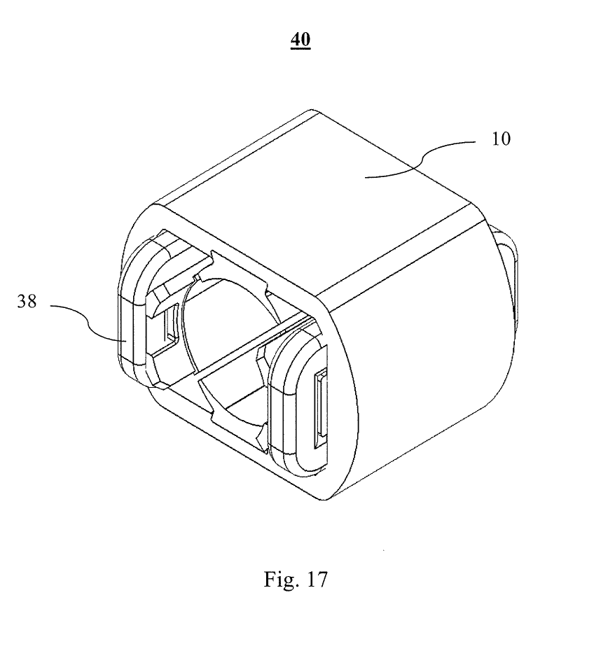

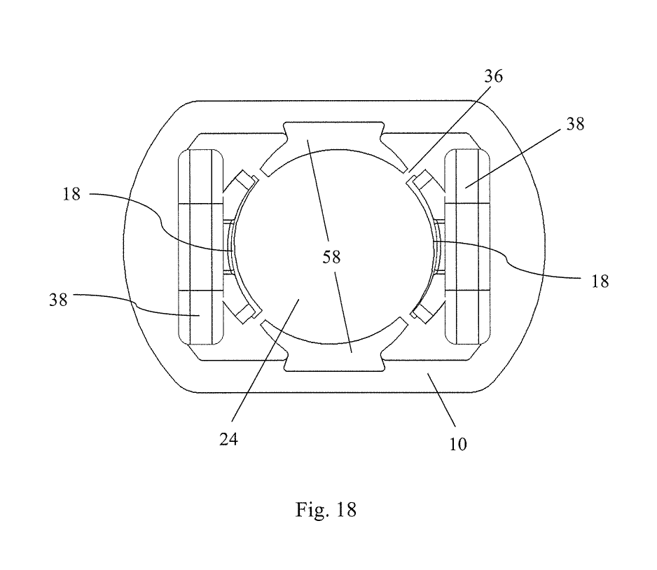

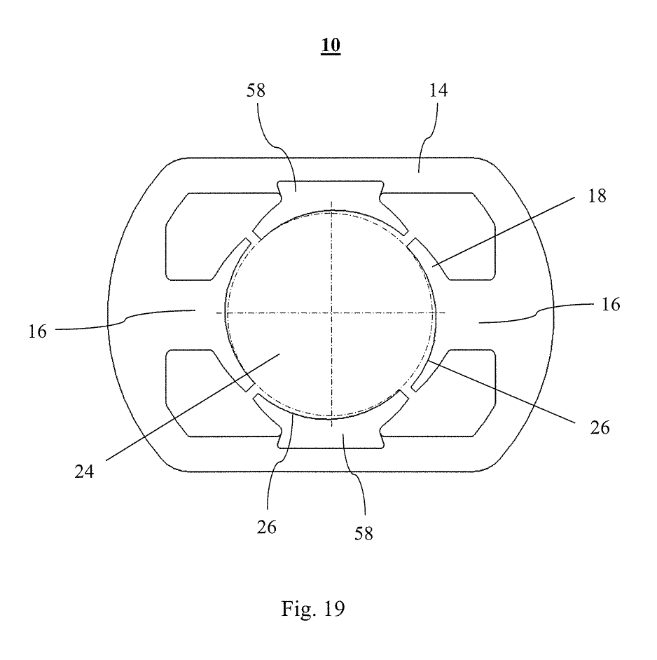

FIGS. 15-21 show the single phase permanent magnet motor according to a fourth embodiment of the present disclosure, which differs mainly in that: the stator core 10 of the motor of this embodiment is a rectangular core which, as shown in FIG. 19, includes a rectangular yoke 14, two arms 16 extending from two opposite sides of the yoke 14, a claw-pole 18 formed at a distal end of each arm 16, and two auxiliary claw-poles 58 formed at the other two opposite sides of the yoke 14. In this embodiment, the yoke 14 is oblong. The two arms 16 extend integrally from inner surfaces of the opposite shorter sides of the yoke 14 towards each other. The claw-pole 18 is formed at a radial inner end of each claw-pole 18, and is arc-shaped. The windings 38 are wound around the arms 16 and are located at outer sides of the claw-poles 18. The two auxiliary claw-poles 58 are formed separately and then connected to inner surfaces of the opposite longer sides of the yoke 14, for magnetically conducting and helping the claw-poles 18 form magnetic flux loops. The two claw-poles 18 and the two auxiliary claw-poles 58 are alternately arranged along the circumferential direction, with narrow gaps 36 formed between neighboring claw-poles 18 and auxiliary claw-poles 58. Inner surfaces of all of the claw-poles 18 and the auxiliary claw-poles 58 are concaved to form the arc pole faces 26. Each arc pole faces 26 are involute curved faces and spiral outwardly along the clockwise direction, as viewed from the aspect shown in FIG. 19. In this embodiment, one magnetic flux loop is formed between one claw-pole 18 and one neighboring auxiliary claw-pole 58 upon the windings being energized and, therefore, the number of the magnetic flux loops is two times of the number of the claw-poles 18.

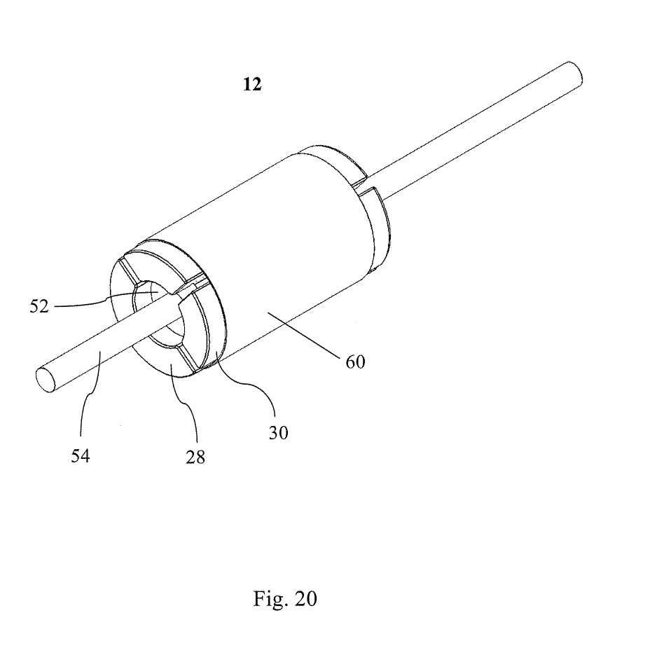

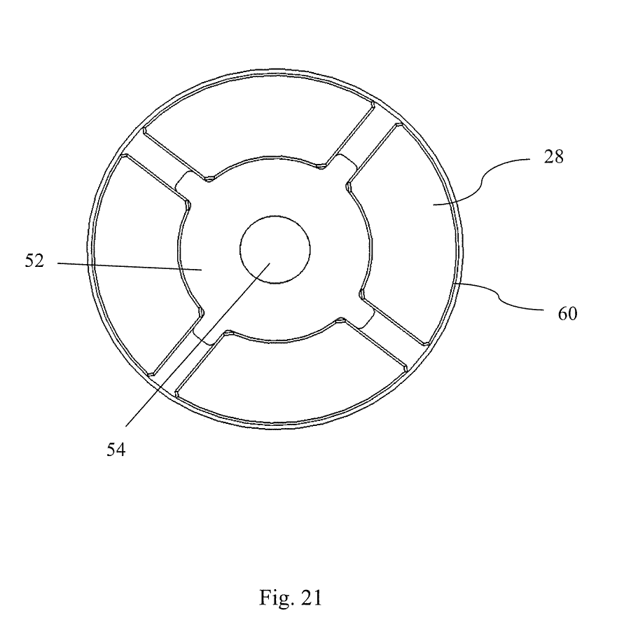

As shown in FIGS. 20-21, the rotor 12 is rotatably received in the space 24 defined by the arc pole faces 26 of the claw-poles 18 and the auxiliary claw-poles 58. The rotor 12 includes a shaft 54, a rotor core 52, a plurality of permanent magnetic poles 28, and a rotor housing 60. The rotor core 52 is fixedly mounted around the shaft 54. The permanent magnetic poles 28 are fixed to the outer surface of the rotor core 52. The rotor housing 60 is mounted around and fixed to the permanent magnetic poles 28. Preferably, the number of the permanent magnetic poles 28 is equal to a total of the numbers of the claw-poles 18 and the auxiliary claw-poles 58. An outer surface of each permanent magnetic pole 28 opposite from the rotor core 52 functions as the magnetic pole face 30 of the permanent magnetic pole 28, and is located on a cylindrical surface which has an axis coinciding with that of the rotor 12. After assembly of the stator 40 and the rotor 12, due to the involute arc pole faces 26 of the stator 40, the air gap 32 between the stator 40 and the rotor 12 is uneven. A radial width of the air gap 32 increases gradually along the spiral direction of the arc pole face 26 of the stator 40 (along the clockwise direction as viewed from the aspect shown in FIG. 19), which effectively avoids the rotor 12 to stop at the dead point position when the motor powers off, and ensures successful startup of the rotor 12 when the motor is energized again. Furthermore, the rotor housing 60 can be made of a conductive magnetic material and, in this case, an outer circumferential surface of the rotor housing 60 functions as the magnetic pole face 30 of the rotor 12, which effectively reduces the air gap 32 between the stator 40 and the rotor 12, thus improving the efficiency of the motor.

In the above embodiments, the gap between the neighboring claw-poles is 0˜6 times of a maximum value of the air gap, preferably, the gap between the neighboring claw-poles is greater than two times of the maximum value of the air gap and less than four times of the maximum value of the air gap.

In the above embodiments, although the stator 40 and the rotor 12 of the motor have some differences in construction and form, their operations are the same in principle. When the motor is energized, a periodically alternating electric current flows through the windings 38 to generate an induced electromagnetic field. As a result, the claw poles 18 of the stator core 10 are polarized, which interact with the permanent magnetic poles 28 of the rotor 12 to drive the rotor 12 which further drives the load to operate. In the embodiments of the present disclosure, all the cores 10 of the stators form the involute arc pole faces 26 which are not continuous in the circumferential direction, and the stator 40 and the rotor 12 define the uneven air gap 32 therebetween. This effectively avoids the rotor 12 to stop at the dead point position when the motor powers off, and facilitates the next startup of the motor. In addition, this can reduce the magnetic flux leakage and ensure efficiency of the motor.

The embodiments described above are illustrative rather than limiting. Various modifications can be apparent to persons skilled in the art without departing from the scope of the invention, and all of such modifications should fall within the scope of the present invention.

1. A single phase permanent magnet motor, comprising:
a stator comprising a stator core and windings wound around the stator core, the stator core comprising a yoke and at least two claw-poles extending from the yoke, each of the claw-poles forming an arc pole face, the arc pole faces of the claw-poles cooperatively defining a space; and
a rotor rotatably disposed in the space of the stator, the rotor comprising at least two permanent magnetic poles, wherein the arc pole face of each claw-pole is an involute curved face, such that an uneven air gap is defined between the arc pole faces and the rotor.

2. The single phase permanent magnet motor of claim 1, wherein each of the permanent magnetic poles comprises a magnetic pole face facing the arc pole face of the stator, and the uneven air gap is defined between the arc pole faces and the magnetic pole faces.

3. The single phase permanent magnet motor of claim 1, wherein a radial distance between each arc pole face and a central axis of the rotor changing gradually from one end of the arc pole face to the other end of the arc pole face along a circumferential direction of the arc pole face, the uneven air gap between each arc pole face and the rotor gradually changes from one end to the other end.

4. The single phase permanent magnet motor of claim 1, wherein the claw-poles are spaced from each other, distal ends of each two neighboring claw-poles define a gap therebetween, the arc pole faces are not continuous in the circumferential direction and are interrupted at the gaps between the claw-poles.

5. The single phase permanent magnet motor of claim 1, wherein the gap between the neighboring claw-poles is 0˜6 times of a maximum value of the air gap.

6. The single phase permanent magnet motor of claim 1, wherein the gap between the neighboring claw-poles is greater than two times of the maximum value of the air gap and less than four times of the maximum value of the air gap.

7. The single phase permanent magnet motor of claim 1, wherein a width of the gap between the claw-poles is substantially two times of the maximum width of the air gap between the stator and the rotor.

8. The single phase permanent magnet motor of claim 1, wherein the stator core is a U-shaped core, and two arms extend from two ends of the yoke, the two arms are parallel to and spaced from each other, each of the arms forms one of the claw-poles at a distal end thereof, and an inner surface of each claw-pole facing the other claw-pole concaves to form the arc pole face.

9. The single phase permanent magnet motor of claim 8, wherein each of the claw-poles is C-shaped, and two ends of each claw-pole protrude towards the other claw-poles to form pole-tips.

10. The single phase permanent magnet motor of claim 1, wherein the stator core is a substantially θ-shaped core, and comprises two yokes parallel to and spaced from each other, two arms respectively interconnect opposite ends of the two yokes, the number of the claw-poles is two, the two claw-poles extend perpendicularly towards each other from middles of the two yokes, and an inner surface of each claw-pole facing the other claw-pole concaves to form the arc pole face.

11. The single phase permanent magnet motor of claim 1, wherein the yoke is annular, a plurality of arms extends radially and inwardly from an inner surface of the yoke, the claw-poles are respectively formed at radial inner ends of the arms, each claw-pole is arc-shaped, and a radial inner surface of each claw-pole functions as the arc pole face of the claw-pole.

12. The single phase permanent magnet motor of claim 11, wherein the core is formed by splicing a plurality of segments, each of the segments comprises an arc-shaped yoke portion, and an arm extending from a radial inner surface of the yoke portion, the claw-poles are respectively formed at distal ends of the arms, one end of each yoke portion in the circumferential direction protrudes outwardly to form a tab, and the other end of each yoke portion concaves to define a recess, and the tab of each yoke portion engages in the recess of one neighboring yoke portion to form the annular yoke.

13. The single phase permanent magnet motor of claim 1, wherein the yoke is substantially rectangular, two arms extend from inner surfaces of two opposite sides of the yoke, the number of the claw-poles is two, the two claw-poles are respectively formed at distal ends of the arms, two auxiliary claw-poles are connected at inner surfaces of the other two opposite sides of the yoke, the two claw-poles and the two auxiliary claw-poles are alternately arranged along the circumferential direction, a radial size of each auxiliary claw-pole is less than that of each claw-pole, and an inner surface of each of the claw-poles and the auxiliary claw-poles concaves to form the arc pole face.

14. The single phase permanent magnet motor of claim 13, wherein the yoke is oblong, the two arms extend integrally from a pair of shorter sides of the yoke, and the two auxiliary claw-poles are formed separately and then connected to a pair of longer sides of the yoke, respectively.

15. The single phase permanent magnet motor of claim 13, wherein the arc pole face of each auxiliary claw-pole is an involute curved face, and the air gap between the arc pole face of each auxiliary claw-pole and the rotor is uneven.

16. The single phase permanent magnet motor of claim 15, wherein the arc pole face of each of the claw-poles and auxiliary claw-poles extends spirally outward along a same circumferential direction.

17. The single phase permanent magnet motor of claim 13, wherein the windings are only wound around the arms which are connected to the claw-poles.
